(19) United States
(12) Patent Application Publication
(10) Pub. No.: US 2018/0129778 A1
(43) Pub. Date: May 10, 2018

(54) SYSTEMS AND METHODS FOR PROVIDING IMPROVED PREDICTION OF CARRIER STATUS FOR SPINAL MUSCULAR ATROPHY

(71) Applicant: GenePeeks, Inc., New York, NY (US)

(72) Inventors: Ari Julian SILVER, New York, NY (US); Lee M. SILVER, New York, NY (US); Jessica L. LARSON, Arlington, MA (US); Carlos BORROTO, Kensington, MD (US); Brett SPURRIER, Brooklyn, NY (US)

(73) Assignee: GenePeeks, Inc., New York, NY (US)

(21) Appl. No.: 15/574,363

(22) PCT Filed: May 27, 2016
(86) PCT No.: PCT/US16/34574

§ 371 Date: Nov. 15, 2017

Related U.S. Application Data
(60) Provisional application No. 62/167,551, filed on May 28, 2015.

(51) Int. Cl. G06F 19/18; G06F 19/22

(52) U.S. Cl. CPC G06F 19/18; G06F 17/18; G06F 19/22

(57) ABSTRACT

Systems and methods of improved genetic mutation carrier screening may include, for a plurality of genetically similar genes in a reference genome, the plurality of genetically similar genes comprising a functional gene and a non-functional gene, masking the non-functional gene from the reference genome; aligning a plurality of functional gene reads and a plurality of non-functional gene reads of a patient's genetic sequence to the functional gene in the reference genome; tallying, at a first polymorphic locus-of-interest on each aligned read, a respective nucleotide type, wherein functional gene reads comprise a different nucleotide type than non-functional gene reads at the first polymorphic locus-of-interest; and calculating, based at least in part on a result of the tallying, a first gene ratio, wherein the first gene ratio indicates a first ratio of functional gene reads to non-functional gene reads.

### FIELD OF THE INVENTION

The present invention relates generally to improved genetic testing, and more specifically, to systems and methods for improved prediction of carrier status for spinal muscular atrophy and similar genetic diseases.

### BACKGROUND OF THE INVENTION

Spinal muscular atrophy (SMA) is a common autosomal recessive disorder (affecting approximately 1/10,000 live births). The disease results from the degeneration of spinal cord motor neurons leading to the atrophy of skeletal muscle and overall weakness. Carrier frequency for SMA is estimated to be about 1/47 in European populations. Prompted by the severity of SMA and its relatively high carrier frequency, there is a widespread interest in screening for carriers in the population.

SMA is caused by mutations in the survival motor neuron gene, SMN1. A similar gene often confused with SMN1 is SMN2, which is located around 1.4 mega base pairs (Mb) away from SMN1 on chromosome 5q13. At the DNA sequencing level, these two genes only differ by five nucleotides (DNA building blocks), only one of which has an impact on the corresponding polypeptide. This single functional difference occurs at the sixth base of the eighth exon (referred to traditionally as “exon 7”) (where SMN1 has a C nucleotide base and SMN2 has a T nucleotide base, commonly notated as “C>T”). A “T” at this site affects the splicing patterns of SMN2; most SMN2 transcripts do not include exon 7. The homozygous absence of SMN1 (and thus exon 7), due to deletion or gene conversion is responsible for approximately 95% of cases of SMA.

DNA-sequencing has emerged as the gold standard to determine the genotype for a region of the genome due to the speed, accuracy, and scaling ability of the technique. These methods rely on the construction of a library of small DNA segments from fragmented DNA. These segments are sequenced in millions of parallel reactions. The resulting newly created strings of bases, called “reads,” can be reassembled using a known reference genome. A reference genome (also known as a reference assembly) is a digital nucleic acid sequence database, assembled as a representative example of a given species' genome. As they are often assembled from the sequencing of DNA from a number of subjects, reference genomes do not accurately represent the genome of any single subject. Instead, a reference provides a haploid amalgam of different DNA sequences from a variety of subjects. Differences between the reads and the reference genome are marked as variants and are used to genotype samples relative to the reference. Since SMN1 and SMN2 are nearly identical in sequence, conventional alignment tools have trouble distinguishing between them and often map their corresponding reads to both regions of the genome.

Because of this insensitivity of Next-Generation Sequencing (NGS), the typical protocol for determining SMA carrier status involves a longer process called comparative real time quantitative polymerase chain reaction (qPCR). In qPCR methods, primers, or short pieces of DNA, are designed to match the specific target segment of the genome. For SMA qPCR, SMN1 primers that specifically amplify segments of exon 7 are used along with a control gene for normalization. The copy number of SMN1 is calculated by comparing its cycle threshold to that of control genes. This and other present methods have proved to be highly inefficient on a large scale, and are not practical for large whole exome or genome studies. Present sequencing methods are restricted by their inability to differentiate between the SMN1 and SMN2 gene paralogs, and require testing for SMA in a process distinct from all other carrier tests that can be multiplexed in a single targeted gene panel.

There is a long felt need inherent in the art for improved DNA-sequencing approaches to determine carrier status for SMA (and other similar genetic diseases) because of the insufficiency of typical DNA-sequencing variant calling techniques and qPCR methods. According to embodiments of the invention, a method and system are provided for improving SMA carrier screening by calculating the likelihood of an SMA carrier with a deletion or gene conversion of at least one copy of SMN1.

### SUMMARY OF EMBODIMENTS OF THE INVENTION

According to embodiments of the invention, there are provided systems and methods of improved genetic mutation carrier screening. In some embodiments, for a plurality of genetically similar genes in a reference genome, the plurality of genetically similar genes comprising a functional gene (FG) (e.g., SMN1) and a non-functional gene (NFG) (e.g., SMN2), one or more processor(s) may mask the NFG from the reference genome; align a plurality of FG reads and a plurality of NFG reads of a patient's genetic sequence to the FG in the reference genome; tally, at a first polymorphic locus-of-interest (LOI) on each aligned read, a respective nucleotide type, wherein FG reads comprise a different nucleotide type than NFG reads at the first polymorphic LOI; and calculate, based at least in part on a result of the tallying, a first gene ratio, wherein the first gene ratio indicates a first ratio of the FG reads to the NFG reads.

In some embodiments, a statistical model may be applied to the first gene ratio. A probability of a carrier status may be determined based at least in part on the first gene ratio. In some embodiments, for at least one other polymorphic LOI on each aligned read, a respective nucleotide type may be tallied, wherein FG reads comprise a different nucleotide type than NFG reads at the at least one other polymorphic LOI; and a second gene ratio may be calculated based at least in part on a result of the tallying at the at least one other polymorphic LOI, wherein the second gene ratio indicates a second ratio of FG reads to NFG reads for the other polymorphic LOI.

In some embodiments, it may be determined whether the first gene ratio and the second gene ratio are within a tolerance threshold. A statistical model may be applied to the first gene ratio and the second gene ratio when the first gene ratio and the second gene ratio are within a tolerance threshold. A probability of a carrier status may be determined given the first gene ratio and the second gene ratio. In some examples, the threshold tolerance may be less than or equal to 10%. In some embodiments, the FG may be the SMN1 gene and the NFG may be the SMN2 gene. In some embodiments, one or more housekeeping genes may be identified. A scaling factor may be calculated based on a ratio of an average number of FG reads to an average number of the one or more housekeeping genes. The determined probability of a carrier status may be normalized based at least in part on the scaling factor.

In some embodiments, identifying the one or more housekeeping genes may further include identifying one or more housekeeping genes which pass a preliminary coverage filter; and determining whether the one or more identified housekeeping genes does not exceed an average coverage variability threshold or does not exceed a proportion variability threshold. The proportion variability threshold may be applied to a proportion of an average coverage for the FG to an average coverage for a particular housekeeping gene.

In accordance with embodiments of the invention, systems may be provided which may be configured to perform embodiments of the methods described herein. Some embodiments of the invention may be performed on a computer, for example, having one or more processor(s), memor(ies), and code set(s) stored in the memor(ies) and executed by the processor(s). These and other aspects, features and advantages will be understood with reference to the following description of certain embodiments of the invention.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A schematically illustrates a first part of a system for performing an improved prediction of carrier status for spinal muscular atrophy and similar genetic diseases, according to an embodiment of the invention;

FIG. 1B is a schematic illustration of a second part of the system for performing an improved prediction of carrier status for spinal muscular atrophy and similar genetic diseases, according to an embodiment of the invention;

FIG. 2 is a schematic flow diagram illustrating a method for performing an improved prediction of carrier status for spinal muscular atrophy and similar genetic diseases according to an embodiment of the invention;

FIG. 3 is an example plot of a proportion of reads aligning to SMN1 for each subject when using raw reads versus those calculated from scaling the reads based on housekeeping ratios, according to an embodiment of the invention;

FIG. 4 is an example plot of posterior probability values versus their frequency in a dataset, according to an embodiment of the invention;

FIG. 5 is an example plot of the observed proportion of reads aligning to SMN1 versus the posterior carrier probabilities plotted for each subject, according to an embodiment of the invention;

FIG. 6 is an example plot of 95% credible intervals for the true proportion of reads aligning to SMN1 for each individual, according to an embodiment of the invention;

FIG. 7A is an example plot of the posterior carrier probabilities stratified by Multiplex Ligation-dependent Probe Amplification (MLPA) assay results for each subject, according to an embodiment of the invention;

FIG. 7B is an example plot of the MLPA outcome versus the posterior carrier probabilities of each subject, according to an embodiment of the invention;

FIG. 8A is a schematic display of a canonical genotype of SMN1 and SMN2, according to an embodiment of the invention;

FIG. 8B is a schematic display of a comparison of SMN1 and SMN2 sequences on either side of the gene-defining transcript position, according to an embodiment of the invention;

FIG. 9A is a schematic display of results of an example SMA carrier screening for a first subject, along with a corresponding genotype representing the genetic makeup of the first subject's SMN genes, according to an embodiment of the invention; and

FIG. 9B is a schematic display of results of an example SMA carrier screening for a second subject, along with a corresponding genotype representing the genetic makeup of the second subject's SMN genes, according to an embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention provide systems and methods for improved prediction of carrier status for spinal muscular atrophy and similar genetic diseases. Repetitive genomic regions are typically difficult to analyze with any sequencing technology because one cannot unambiguously align a read to a non-unique sequence. One strategy to overcome this hurdle involves masking the reference genome. This requires removing one of the identical regions from the reference sequence, so that no reads align to this location. A key setback of this masking strategy is the inability to differentiate the positional source of each read, which is essential for extracting SMA carrier status.

Embodiments of the invention overcome limitations in SMA detection status with Next-Generation Sequencing data.

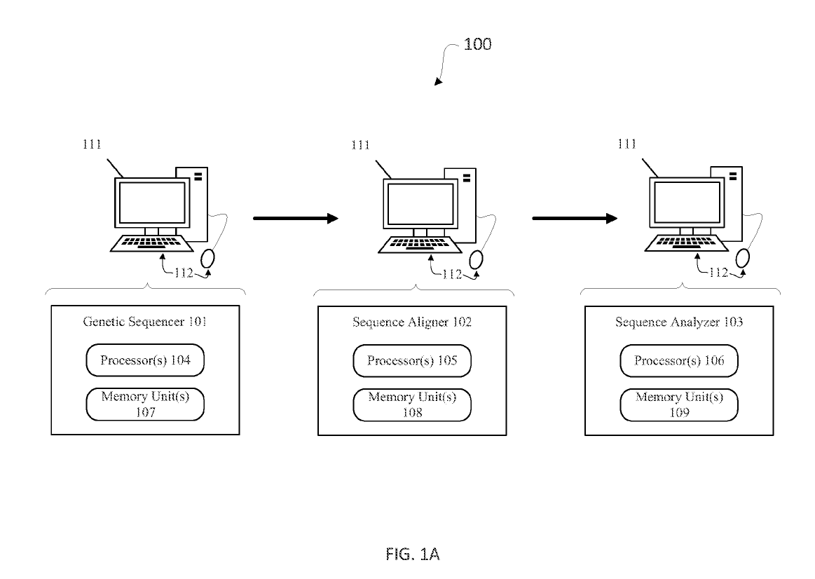

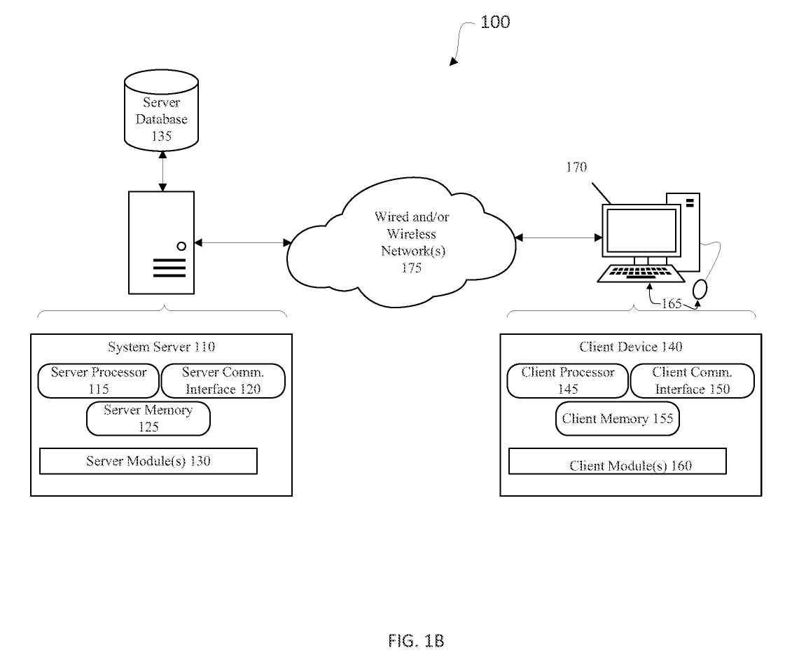

FIG. 1A schematically illustrates a first part of a system 100 for performing an improved prediction of carrier status for spinal muscular atrophy and similar genetic diseases, according to an embodiment of the invention. In some embodiments, system 100 may include a genetic sequencer 101, a sequence aligner 102 and/or a sequence analyzer 103. Units 101-103 may be implemented in one or more computerized devices as hardware and/or software units, for example, specifying instructions configured to be executed by a processor. One or more of units 101-103 may be implemented as separate devices or combined as an integrated device.

Genetic sequencer 102 may input DNA obtained from biological samples, such as, blood, tissue, or saliva, of one or more real living organisms and may output each organism's genetic sequence including the organism's genetic information at one or more genetic loci, for example, a human genome. A single organism's DNA sample may be sequenced for performing carrier testing on that individual.

Sequence aligner 102 may align, whenever possible, one or more loci corresponding to SMN1 and SMN2 reads of a genetic sequence or patient or subject being screened with specific reference points (e.g., similar SMN1 and SMN2 reference points) of reference genetic sequence. In some embodiments, a sequence aligner need not be used.

Sequence analyzer 103 may input multiple sequence alignments and may compute measures to perform various operations relating to prediction of carrier status for spinal muscular atrophy and similar genetic diseases, and other functions of embodiments of the invention as will be described in greater detail below.

Genetic sequencer 101, sequence aligner 102, and sequence analyzer 103 may include one or more controller(s) or processor(s) 104, 105, and 106, respectively, configured for executing operations and one or more memory unit(s) 107, 108, and 109, respectively, configured for storing data such as genetic information or sequences and/or instructions (e.g., software) executable by a processor, for example for carrying out methods as disclosed herein. Processor(s) 104, 105, and 106 may include, for example, a central processing unit (CPU), a digital signal processor (DSP), a microprocessor, a controller, a chip, a microchip, an integrated circuit (IC), or any other suitable multi-purpose or specific processor or controller. Processor(s) 104, 105, and 106 may individually or collectively be configured to carry out embodiments of a method according to the present invention by for example executing software or code. Memory unit(s) 107, 108, and 109 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. Genetic sequencer 101, sequence aligner 102, and/or sequence analyzer 103 may include one or more input/output devices, such as output display 111 (e.g., such as a monitor or screen) for displaying to users results provided by sequence analyzer 103, and an input device 112 (e.g., such as a mouse, keyboard or touchscreen) for example to control the operations of system 100 and/or provide user input or feedback.

FIG. 1B is a schematic illustration of a second part of the system 100 for performing an improved prediction of carrier status for spinal muscular atrophy and similar genetic diseases, according to an embodiment of the invention. System 100 may include network 175, which may include the Internet, one or more telephony networks, one or more network segments including local area networks (LAN) and wide area networks (WAN), one or more wireless networks, or a combination thereof. System 100 also includes a system server 110 constructed in accordance with one or more embodiments of the invention. In some embodiments, system server 110 may be a stand-alone computer system. In other embodiments, system server 110 may include a network of operatively connected computing devices, which communicate over network 175. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 175.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 110 may include a server processor 115 which is operatively connected to various hardware and software components that serve to enable operation of the system 100. Server processor 115 serves to execute instructions or software to perform various operations relating to prediction of carrier status for spinal muscular atrophy and similar genetic diseases, and other functions of embodiments of the invention as will be described in greater detail below. Server processor 115 may be one or a number of processors, a central processing unit (CPU), a graphics processing unit (GPU), a multi-processor core, or any other type of processor, depending on the particular implementation.

System server 110 may be configured to communicate via server communication interface 120 with various other devices connected to network 175. For example, server communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 is accessible by server processor 115, thereby enabling server processor 115 to receive and execute instructions such as code, stored in the memory and/or storage in the form of one or more software modules 130, each module representing one or more code sets or software. The software modules 130 may include one or more software programs or applications (collectively referred to as the “server application”) having computer program code or a set of instructions executed partially or entirely in or by server processor 115 for carrying out operations for aspects of the systems and methods described herein, and may be written in any combination of one or more programming languages. Server processor 115 may be configured to carry out embodiments of the present invention by for example executing code or software, and may be or may execute the functionality of the modules as described herein.

It should be noted that in accordance with various embodiments of the invention, server modules 130 may be executed entirely on system server 110 as a stand-alone software package, partly on system server 110 and partly on a client device 140, or entirely on client device 140.

Server memory 125 may be, for example, a random access memory (RAM) or any other suitable volatile or non-volatile computer readable storage medium. Server memory 120 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 175. Database 135 may include any of the memory configurations as described above, and/or may be in direct or indirect communication with system server 110.

As described herein, among the computing devices on or connected to the network 175 may be one or more client devices 140. Client device 140 may be any standard computing device. As understood herein, in accordance with one or more embodiments, a computing device may be a stationary computing device, such as a desktop computer, kiosk and/or other machine, each of which generally has one or more processors, such as client processor 145, configured to execute code or software to implement a variety of functions, a client communication interface 150, a computer-readable memory, such as client memory 155, for connecting to the network 175, one or more client modules, such as client module(s) 160, one or more input devices, such as input devices 165, and one or more output devices, such as output devices 170. Typical input devices, such as, for example, input devices 165, may include, for example, a keyboard, a pointing device (e.g., mouse or digitized stylus), a web-camera, and/or a touch-sensitive display, etc. Typical output devices, such as, for example, output device 170 may include one or more of a monitor, display, speaker, printer, etc.

In some embodiments, client module 160 may be executed by client processor 145 to provide the various functionalities of client device 140. In particular, in some embodiments, client module 160 may provide a client-side interface with which a user of client device 140 may interact, to, among other things, provide a previously unscreened DNA sample or genetic map for carrier screening, as described herein.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, client device 140 may be a “dummy” terminal, by which processing and computing may be performed on system server 110, and information may then be provided to client device 140 via server communication interface 120 for display and/or basic data manipulation. In some embodiments, modules depicted as existing on and/or executing on one device may additionally or alternatively exist on and/or execute on another device. In some embodiments, one or more components of system 100 may be unnecessary to perform aspects of the invention. For example, in embodiment in which NGS data is provided, e.g., by a third party or directly by a subject, the need for genetic sequencer 101 would be obviated.

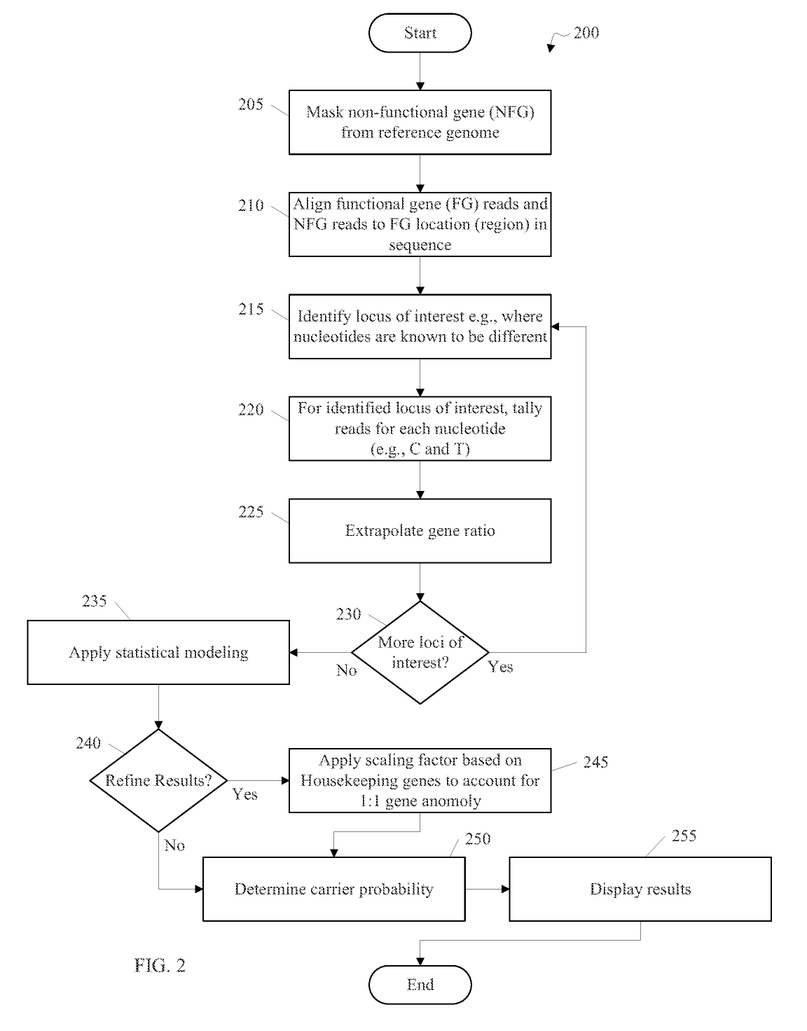

FIG. 2 is a schematic flow diagram illustrating a method 200 for performing an improved prediction of carrier status for spinal muscular atrophy and similar genetic diseases according to an embodiment of the invention. In some embodiments, method 200 may be performed on a computer (e.g., system server 110) having one or more processors (e.g., server processor 115), one or more memories (e.g., server memory 125), and one or more code sets or software (e.g., server module(s) 130) stored in the memory and executed by the processor.

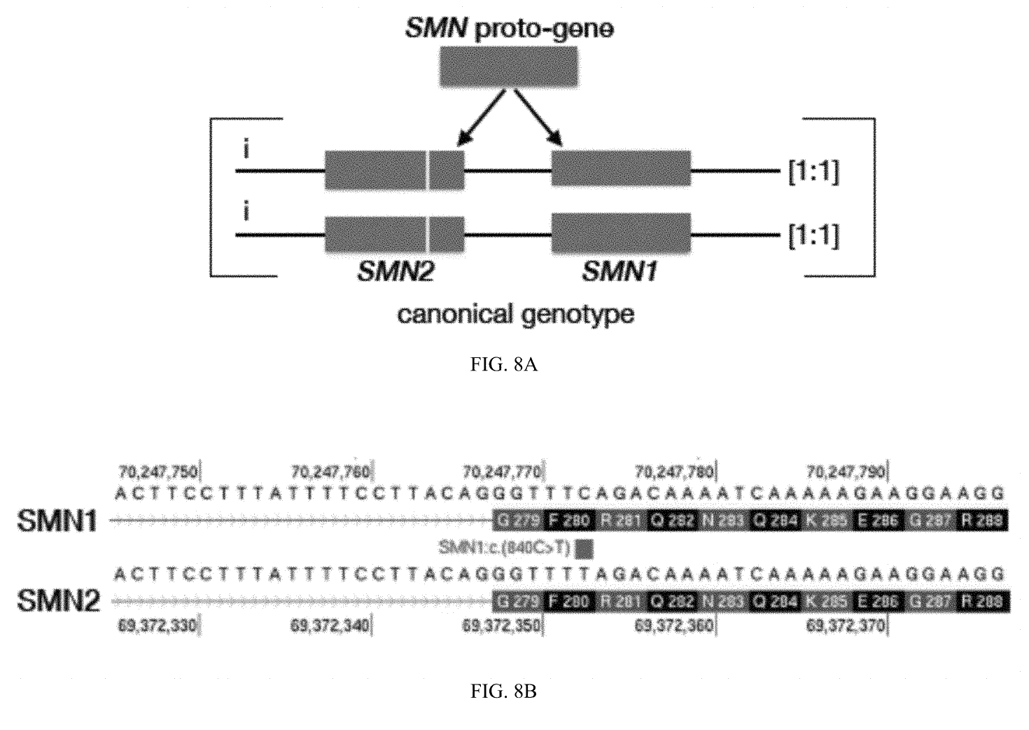

At step 205, in some embodiments, for a plurality of (e.g., two or more) genetically similar genes in a reference genome, the plurality of genetically similar genes including at least one functional gene (FG) and at least one non-functional gene (NFG), the processor may mask all instances of the NFG from the reference genome. As understood herein, in various embodiments, genetically similar genes may be, for example, genes that are homologous, orthologous, and/or paralogous in relation to one another. As understood herein, a homologous gene is a gene related to a second gene by descent from a common ancestral DNA sequence. (See, e.g., FIG. 8A.) The term homolog may apply to the relationship between genes separated by the event of speciation and/or to the relationship between genes separated by the event of genetic duplication. As understood herein, speciation is the origin of a new species capable of surviving in a new way from the species from which it arose, e.g., having requirements for survival that are different than the original species. As part of this process, the new species typically also acquires some barrier to genetic exchange with the parent species, and/or contains genes which do not function in the same way as the parent species. Orthologs (orthologous genes) are genes in different species that evolved from a common ancestral gene, e.g., by speciation. Normally, though not necessarily, orthologs retain the same function in the course of evolution. Identification of orthologs is an important factor for reliable prediction of gene function in newly sequenced genomes. Paralogs (paralogous genes) are genes related by duplication within a genome. Orthologs typically retain the same function in the course of evolution, whereas paralogs typically evolve new and/or different functions, even if these are related to the original function.

A functional gene, as understood herein, is a gene that fully performs its expected and/or intended function. A non-functional gene, as understood herein, is a gene which, due to gene duplication, gene mutation, etc., does not fully perform its expected and/or intended function. Note that any gene which is not fully functional, e.g., a gene which is completely non-functional and/or a gene which is only partially functional with respect to a genetically similar fully functional gene, is referred to herein as non-functional. By way of example, as part of its expected/intended function, the SMN1 gene provides instructions for making the survival motor neuron (SMN) protein. The SMN protein is found throughout the body, with particularly high levels found in the spinal cord. This protein is important for the maintenance of specialized nerve cells called motor neurons, which are located in the spinal cord as well as the part of the brain that is connected to the spinal cord (the brainstem). Motor neurons control muscle movement.

The SMN protein plays an important role in processing molecules inside cells called messenger RNA (mRNA), which serve as messengers that transfer the genetic blueprints from DNA for making proteins. Messenger RNA begins as pre-mRNA and is processed through several processing steps to become RNA in its mature form. The SMN protein helps to assemble the cellular components needed to process pre-mRNA. The SMN protein is also believed to be important for the development of specialized outgrowths from nerve cells called dendrites and axons. Dendrites and axons are required for the transmission of impulses between nerves and from nerves to muscles.

The SMN2 gene is a genetically similar gene to the SMN1 gene, but does not have the same full functionality of the SMN1 gene. At the sequence level, these two genes are distinguished by just five nucleotides. The critical nucleotide difference that makes SMN2 only partially functional is a C to T transition at position 6 of exon 7, which leads to the exclusion of exon 7 in the majority of SMN2 transcripts. (See, e.g., FIG. 8B.) This mRNA is subsequently translated to form an unstable form of SMN protein. However, the SMN2 gene still produces 5-10% functional full-length SMN transcripts. Both the SMN1 and SMN2 genes are present in variable copy numbers in the general population, and all SMA patients have one or more copies of the SMN2 gene. Due to its partial functionality, SMN2 acts as a positive disease modifier, since it can help mitigate some of the damage related to the homozygous absence of SMN1. There is thus an inverse correlation between the number of SMN2 gene (which can produce between 10-50% of SMN protein depending on copy number) and the severity of the SMA disease. Low levels of SMN protein typically allow for embryonic development but are not enough, in the long term, to allow motor neurons to survive in the spinal cord. In other embodiments, two or more other genes (besides those associated with production of the SMN protein) may be genetically similar, with one or more being fully functional, one or more being partially functional, and/or one or more being completely non-functional. As such, embodiments of the invention may be applied to those genes fitting the same criteria as those described herein with regard to SMN genes.

As understood herein, ‘masking’ may refer to the procedure of transforming a particular nucleotide or set of nucleotides in the reference genome to a predefined masking marker, e.g., an ‘N’ (which does not correspond to any of the four types of nucleotides: adenine (“A”), guanine (“G”), cytosine (“C”), and thymine (“T”), and thus prevents alignment with the “masked” nucleotide). Other methods of masking may also be implemented, provided the NFG is effectively masked as a result such that reads cannot be aligned to a masked nucleotide. Likewise, in other embodiments, masking may be unnecessary, for example, provided the FG and NFG reads are forced to align with the desired nucleotide, e.g., using other alignment methods.

At step 210, in some embodiments, the processor may align (e.g., via an alignment tool) a plurality of the FG reads and a plurality of NFG reads (e.g., SMN1 reads and SMN2 reads) to the FG (e.g., SMN1) reference genome. In some embodiments, the processor may align (e.g., via the alignment tool) all of the FG reads and all of NFG reads (e.g., SMN1 reads and SMN2 reads) to the FG (e.g., SMN1) reference genome.

At step 215, in some embodiments, the processor may identify a first locus-of-interest (LOI) where nucleotides of the FG and NFG are known or found to be different. A locus (or ‘loci’ for a plurality) is the specific location of a gene, DNA sequence, or position on a chromosome. A variant nucleotide (of a given gene) located at a given locus is called an allele, and such a locus may be referred to as a single nucleotide polymorphism (SNP) or a polymorphic locus. Each SNP represents a difference in a single nucleotide. For example, a SNP may replace the nucleotide cytosine with the nucleotide thymine in a certain stretch of DNA, as is the case in SMA (e.g., gene conversion of SMN1 to SMN2), though not all SNPs are indicative of a disease or health risk; many genetic mutations are harmless.

In some embodiments, there may be only one LOI, while in other embodiments there may be a plurality of loci-of-interest (LOIs), one or more of which may be of greater interest than the others. For example, when examining the differences between the SMN1 and SMN2 genes, the main locus of interest is found in exon 7 (hg19 chr5: 70247773), which is one of the few bases that differ between SMN1 and SMN2. At this locus, SMN1 has a C as the reference base, and SMN2 has a T as the reference base. This information may be a key in enabling attribution of each read to a specific gene, as discussed in detail herein.

It should be noted that in some embodiments, the LOI may be determined ahead of time, and/or identified, e.g., by reference to a look-up table which indicates the locations of alleles. In other embodiments, two or more genes thought to be genetically similar may be compared, and loci containing alleles may be identified as LOI.

At step 220, in some embodiments, the processor may tally, at a first polymorphic LOI on each aligned read, a respective nucleotide type, e.g., such that a number of instances of each of a plurality of nucleotide types (e.g., A, T, C, G, or only T and C) is ascertained with respect to all aligned reads, in which FG reads at the first polymorphic LOI comprise a different nucleotide type than NFG reads. For example, in a set of 100 reads, there may be, for example, 50 reads indicating a T at the first polymorphic LOI, and 50 reads indicating a C at the first polymorphic LOI. As such, the number of nucleotides of each type may be tallied or counted, e.g., as the reads are processed.

At step 225, in some embodiments, the processor may calculate a first gene ratio, e.g., based at least in part on a result of the tallying. The first gene ratio may indicate, for example, a first ratio of FG reads to NFG reads. For example, in SMA carrier screening, by tallying and comparing the number of aligned reads with a C base to the number of aligned reads with a T base, the gene ratio of SMN1:SMN2 may be extrapolated. Wild-type individuals (e.g., individuals having a phenotype of the typical form of a species as it occurs in nature) have two copies of each gene and thus exhibit an SMN1:SMN2 ratio of 1:1. Carriers of SMA, due to the deletion of SMN1 or gene conversion of SMN1 to SMN2, have SMN1:SMN2 gene ratios less than one, for example, 1:2, 1:3, 1:4, etc. Comparing SMN1 reads over the total number of reads for both genes, the above ratios, 1:2, 1:3, 1:4, etc., translate to proportions, 1/3, 1/4, 1/5, respectively, which are all less than or equal to 1/3. As such, carriers of SMA have a proportion of reads SMN1:(SMN1+SMN2) at the polymorphic loci in and around exon 7 that is less than or equal to 1/3.

At step 230, in some embodiments, the processor may determine whether one or more additional LOI are to be identified. If there are additional LOI, the processor may iteratively repeat the above operations to generate a gene ratio for each additional LOI identified at step 215, and the method may continue until all relevant gene ratios have been extrapolated. For example, in SMA carrier screening, in addition to the main LOI found in exon 7 (chr5: 70247773), the processor may further identify and examine two nearby intronic sites (loci) that also differ between SMN1 and SMN2 genes (chr5: 70247724 and chr5: 70247921, respectively), e.g., to increase the statistical power of any statistical calculations related to the gene ratios.

At step 235, in some embodiments, the processor may apply a statistical model (e.g., a modeling algorithm) to the first gene ratio, and determine a probability of a carrier status based, at least in part, on the first gene ratio. In some embodiments, the statistical modeling algorithm may be applied to a plurality of gene ratios, e.g., the first gene ratio and the second gene ratio, etc., and the processor may determine a probability of a carrier status given the plurality of ratios. For example, in SMA carrier screening, a Bayesian hierarchical model may be applied to quantify the probability that an individual has lost at least one copy of SMN1 given his/her distribution of aligned reads to SMN1, e.g., at three of the loci that differ between SMN1 and SMN2. In some embodiments, an assumption may be that the number of reads aligning to SMN1 (D) can be modeled by a binomial distribution with a fixed number of total reads (r). A parameter of interest, π, may be defined as the probability that a read aligned to this region is actually from SMN1. In some embodiments, a non-informative prior may be used (non-informative priors may express “objective” information, and/or may assign equal probabilities to all possibilities), thereby making inferences on the data itself rather than prior beliefs. The more reads that are available, the less relevant the prior will be to the analysis. Implementation of the method according to at least one embodiment is outlined herein.

Assuming reads are aligned to either a SMN1 gene or SMN2 gene at the three polymorphic sites, the number of SMN1 reads may be binomially distributed: Dᵢ˜Bin(rᵢ; πᵢ), where πᵢ is the probability that a given SMN1 or SMN2 read is actually from SMN1 for the ith subject (i=1, 2, . . . , N) (as opposed to the SMN1 or SMN2 read actually being from an SMN2 gene) and rᵢ is the total number of reads aligned to SMN1 when SMN2 is masked. Thus, in the example embodiment,

$$P ( {D}_{i} = {d}_{i} \vert {r}_{i} , {π}_{i} ) = ( \begin{matrix}{r}_{i} \\ {d}_{i}\end{matrix} ) {{π}_{i}^{{d}_{i}} ( 1 - {π}_{i} )}^{{r}_{i} - {d}_{i}} \cdot {\hat{π}}_{i} = \frac{{D}_{i}}{{r}_{i}}$$

may be used to represent an estimate of πᵢ. (Note: the i notation is excluded for the remainder of the description of this implementation, and only one subject is considered; of course, the herein described methods are iterated over i=1, 2, . . . , N for all N subjects in a group, study, or population.)

In some embodiments, the processor may only apply the statistical model to a plurality of LOI when the respective ratios are within a tolerance range or threshold. As such, in some embodiments, the processor may determine, for example, whether the first gene ratio and the second gene ratio are within a tolerance threshold; apply a statistical modeling algorithm to the first gene ratio and the second gene ratio, when the first gene ratio and the second gene ratio are within the tolerance threshold; and determine a probability of a carrier status given the first gene ratio and the second gene ratio.

For example, in SMA carrier screening, if |\hat{π}_{b}−\hat{π}ₐ|>∈ or |\hat{π}_{b}−\hat{π}_{c}|>∈, where \hat{π}_{b} represents the proportion of reads aligned to SMN1 at the main (e.g., middle) locus (and similarly for the other two loci represented by a and c), for some tolerance threshold ∈>0 (e.g., ∈=0.10), then the ∈ condition is not met. That is, if the proportion of reads that align to SMN1 at either of the two sites outside of exon 7 differs from the one in exon 7 by more than 10%, the processor may be configured to calculate the observed proportion based only on reads aligning to exon 7 (e.g., \hat{π}=\hat{π}_{b}). Other tolerance thresholds may also be implemented depending on the desired sensitively/accuracy, such as, for example a tolerance threshold preferably in the range of 0-50%, and more preferably in the range of 0-25%, and even more preferably in the range of 0-10%. Subjects for whom this is the case typically have low sequencing coverage (e.g., coverage of reads) in this region of the genome and thus more noisy (e.g., variable) data. For most subjects, it is possible to pool information across all three polymorphic loci (e.g., a, b and c).

Sequencing coverage (or “coverage”) describes the average number of reads that align to, or “cover,” known reference bases. The NGS (next-generation sequencing) coverage level often determines whether variant discovery can be made with a certain degree of confidence at particular base positions. Sequencing coverage requirements may vary by application. At higher levels of coverage, each base is covered by a greater number of aligned sequence reads, so base calls can be made with a higher degree of confidence.

For notation simplicity, D is used herein to denote the number of reads that align to SMN1 in general. In some embodiments, when a sample ‘fails’ the c condition, D and r only include reads aligned to the site in exon 7; otherwise, reads aligned to all three sites may be included in the calculations of D and r. The binomial distribution allows for modeling the reads in a dataset; however, the inference of greatest interest relates to π. Of particular importance is the following:

P(subject is a carrier|sequencing data)

=P(ratio of SMN1reads to SMN2reads is <1, e.g., 1:2,1:3,etc.)

=P(proportion of SMN1reads out of total reads is ≤1/3, e.g., 1/4,1/5,etc.)

=P(π≤1/3|D,r).

Using Bayes' rule,

$$P ( A \vert B ) = \frac{P ( A ) P ( B \vert A )}{P ( B )} ,$$

a (conjugate) prior may be assumed for π:π˜Beta(α,β). Jeffrey's non-informative prior may be used (α=β=½) for π, for example. Thus, for a given set of sequencing data, the posterior distribution for π may follow a Beta distribution:

π|D,r˜Beta(α+D,r−D+β).

In some embodiments, corresponding carrier probabilities may be calculated, e.g., P(π≤1/3|D,r), directly via the cumulative distribution function of the adjusted Beta distribution. In some embodiments, to be more conservative, the quantity P(π≤0.38|D,r) may be calculated as each individual's probability of being an SMA carrier. This method may be expanded to cases where a locus is not biallelic with a multinomial/Dirichlet model.

In approximately 1% of cases, an SMA carrier has a single copy of each SMN gene, e.g., one SMN1 gene and one SMN2 gene, as opposed to wild-type individuals who have two copies of each gene. This scenario can impact embodiments of the method described herein, since the resulting 1:1 gene ratio may be indistinguishable from wild-type. To account for this potential ambiguity, at step 240 the processor may be configured to determine whether to refine results of the statistical modeling. For embodiments in which accounting for the potential ambiguity is desired or required, at step 245 the processor may examine the gene coverage of SMN1/2 compared to, e.g., the coverage of several housekeeping genes, and derive a relative SMN1/2 gene copy number. In some embodiments, this may be accomplished, for example, by applying a scaling factor based on the coverage of several housekeeping genes. Housekeeping genes are genes which are involved in basic cell maintenance and, therefore, are typically expected to maintain constant expression levels in all cells of an organism under normal conditions.

In some embodiments, the processor may first identify one or more housekeeping genes to be used. Housekeeping genes may be selected, for example, based on their high coverage and low variability in the majority of subjects. In SMA carrier screening, for example, most individuals (e.g., wild-type individuals) will typically have two genes (SMN1 and SMN2) aligning to the SMN1 region (4 total gene copies) for every one reference or housekeeping gene (2 gene copies). In some embodiments, the processor may then calculate a scaling factor, e.g., based on a ratio of an average number of FG reads (e.g., SMN1 reads) to an average number of the one or more housekeeping genes, and normalize the determined probability of a carrier status based at least in part on the scaling factor.

By way of example, in SMA carrier screening, the processor may account for the number of SMN1/2 copies (e.g., reads which may actually be from SMN1 or SMN2, but which have been aligned to SMN1, e.g., due to the masking or some other method) with a weighted average of the SMN1:housekeeping ratios (e.g., the “scaling factor”). Considering K ‘housekeeping’ genes (k=1, 2, . . . , K), zᵢₖ=cᵢ/Hᵢₖ may be calculated, where cᵢ is the average coverage for the SMN1 gene region and Hᵢₖ is the average coverage for gene k in the ith subject.

In some embodiments, a weighted average of the coverage of SMN1 to K housekeeping genes:

$${\hat{θ}}_{i} = \frac{{\sum }_{k = 1}^{K} {z}_{ik} / \overline{{z}_{k}}}{K}$$

may be calculated, where

$$\overline{{z}_{k}} = \frac{{\sum }_{i = 1}^{N} {z}_{ik}}{N} .$$

In some embodiments, to be conservative, any copy number increases in SMN1/2 relative to the housekeeping genes (e.g., \hat{θ}ᵢ>1) may be ignored, in which the scaling factor may have a ceiling (e.g., of 1.00). \hat{θ}ᵢ may then be used to scale observed SMN1 reads to D′ᵢ=\hat{θ}ᵢDᵢ. In this way, embodiments of the invention may account for the number of SMN1/2 reads relative to low variability regions. It will be understood by those of ordinary skill in the art that selecting housekeeping genes to be representative of genome-wide copy-number is nontrivial. In some embodiments, only genes that have sufficiently high coverage in the majority of subjects (e.g., in a given population or group) may be included. Genes with low coverage (e.g., <the 5th percentile in ≥20 people) may not be considered. In some embodiments, those housekeeping genes which pass this coverage filter may then be selected, e.g., for at least one of two properties: (1) low variability in average coverage across all samples (e.g., do not exceed a predefined average coverage variability threshold), and/or (2) low variability in zᵢₖ across all samples (e.g., do not exceed a proportion variability threshold, in which the proportion variability threshold is applied to a proportion of an average coverage for the SMN1 gene to an average coverage for a particular housekeeping gene). To account for differences in scale, in some embodiments, the coefficient of variation (\hat{σ}/\hat{μ}) may be used to rank the variability of each gene.

Individuals with two copies of a FG, two copies of a NFG, and two copies of each housekeeping region would be expected to have zᵢₖ=2 ∀k and thus \hat{θ}ᵢ=1. For SMA carrier screening, therefore, individuals with two copies of SMN1, SMN2, and each housekeeping region would be expected to have zᵢₖ=2 ∀k and thus \hat{θ}ᵢ=1 (Table 1 below). Those with fewer than two copies of SMN1 and/or SMN2 would be expected to have \hat{θ}ᵢ<1 (Table 1 below). Therefore, by combining the SMN1/2 copy number and SMN1:SMN2 ratio, embodiments of the invention may accurately determine carrier status for the vast majority of individuals based on their DNA-sequencing data. For example, when half of the reads align to SMN1 (because of either a 2:2 or 1:1 SMN1:SMN2 genotype ratio), the scaling factor, according to embodiments of the invention, may be especially critical in determining carrier status.

TABLE 1
Theoretical results for hypothetical SMA carrier screening subjects:

| SMN1 copy number | SMN2 copy number | \hat{θ} | Population frequency (%) | D | D′ | r | $\frac{{D}^{′}}{r} = \hat{{π}^{′}}$ | Posterior Likelihood P(π ≤ 0.38\|D′, r) Conclusion |
|---|---|---|---|---|---|---|---|---|
| 1 | 0 | 0.25 | <1 | 100 | 25 | 100 | 0.25 | Likely carrier |
| 1 | 1 | 0.50 | <1 | 100 | 50 | 200 | 0.25 | Likely carrier |
| 2 | 0 | 0.50 | 5-6 | 200 | 100 | 200 | 0.50 | Unlikely carrier |
| 1 | 2 | 0.75 | 1-2 | 100 | 75 | 300 | 0.25 | Likely carrier |
| 2 | 1 | 0.75 | 30-40 | 200 | 150 | 300 | 0.50 | Unlikely carrier |
| 1 | 3 | 1.00 | <1 | 100 | 100 | 400 | 0.25 | Likely carrier |
| 2 | 2 | 1.00 | 45-50 | 200 | 200 | 400 | 0.50 | Unlikely carrier |
| 3 | 1 | 1.00 | 5 | 300 | 300 | 400 | 0.75 | Unlikely carrier |
| 4 | 0 | 1.00 | <1 | 400 | 400 | 400 | 1.00 | Unlikely carrier |
| 1 | 4 | 1.00 | <1 | 100 | 100 | 500 | 0.20 | Likely carrier |
| 2 | 3 | 1.00 | 1-3 | 200 | 200 | 500 | 0.40 | Likely/Unlikely |
| | | | | | | | | carrier¹ |
| 3 | 2 | 1.00 | 1-2 | 300 | 300 | 500 | 0.60 | Unlikely carrier |
| 4 | 1 | 1.00 | <1 | 400 | 400 | 500 | 0.80 | Unlikely carrier |

¹In some embodiments, if a subject has an above threshold number of reads with a clear ratio of 2:3, then he or she may not be labeled as a carrier. If, on the other hand, a subject has a below threshold number of reads, then he or she may be labeled as a carrier. These samples may be the most difficult to determine; however, this ratio is one of the least common non-carrier genotypes. In some embodiments, (e.g., when the number of reads is below a predetermined threshold) to be conservative, the processor by be configured to flag, label or otherwise indicate such people in this population as carriers who are, in fact, not carriers, and/or indicate that the data is inconclusive, etc.

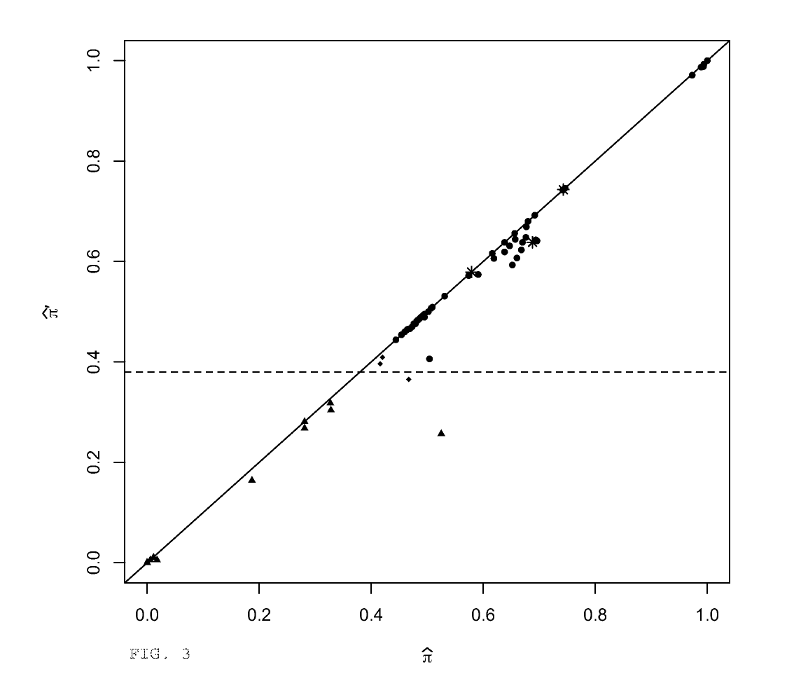

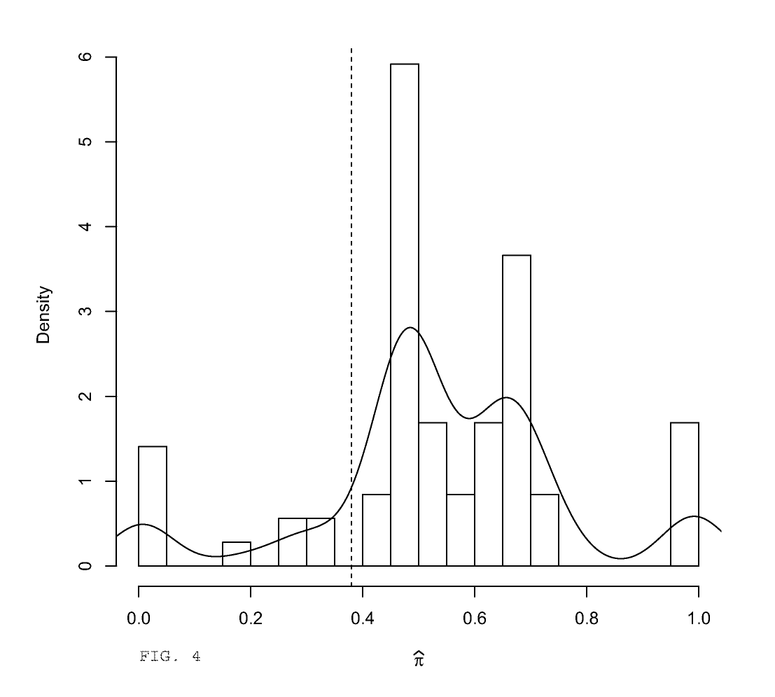

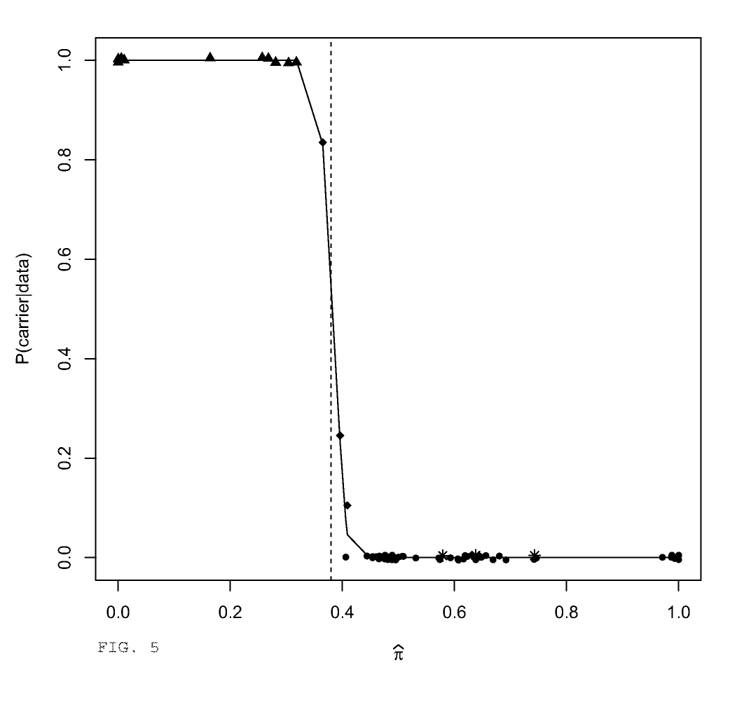

By way of example, the posterior probability P(π≤0.38|D′,r) for 71 subjects was calculated, according to various embodiments of the invention, including 49 saliva, seven (7) semen, and 15 Coriell Institute for Biomedical Research's Biorepository samples. Sequencing reads were pooled for 68 subjects; the remaining 3 did not meet the E criteria. In general, the values used for \hat{π} are tightly correlated with each other regardless of the pooling status of each sample. As expected, most samples with \hat{π} values near 0 or 1 had \hat{θ} values at or near 1 (see e.g., FIG. 3). Genes with the lowest coverage (e.g., genes which failed the ∈ criteria) were more affected by θ<1. Eleven of sixty-eight subjects were determined to be likely SMA carriers, P(π≤0.38|D′,r); three others were determined to be possible carriers, 0.05<P(π≤0.38|D′,r)<0.95, with varying likelihoods (FIG. 4). Subjects with small values for \hat{π} were determined to be likely carriers; those with large values were determined to be unlikely to be carriers (FIG. 5). Individuals with \hat{π} values near or just above 1/3 were determined to be possible carriers, and were assigned likelihood values near 0.5 (FIG. 6).

FIG. 3 is an example plot of \hat{π} (proportion of reads aligning to SMN1) values for each subject when using the raw reads (x-axis) versus those calculated from scaling the reads based on housekeeping ratios (y-axis), according to an embodiment of the invention. Subjects represented by stars did not meet the ∈ criteria; they have a relatively high level of variability across all three LOI sites. Almost all subjects either have the same value for both scaled and unscaled \hat{π} (e.g., they fall exactly on the solid diagonal line because \hat{θ}=1), or they have smaller scaled \hat{π} values (e.g., they fall below the solid diagonal line because \hat{θ}<1). Individuals whose scaled \hat{π} is below the horizontal dashed line at 0.38 are likely carriers. Subjects represented by triangles are likely carriers; their posterior intervals are entirely below the 0.38 threshold cutoff. The intervals of subjects represented by a diamond overlap with the 0.38 threshold; these subjects are possible carriers. After the subjects' data is calculated, the scaled reads and \hat{π}′ may be subsequently used in place of the raw reads for analysis.

FIG. 4 is an example plot of the posterior probability P(π≤0.38|D′,r) values versus each value's frequency in a dataset of e.g., 71 people, according to an embodiment of the invention. Most subjects have a \hat{π} to the right of the vertical dashed threshold line, e.g., at 0.38, indicating that it is unlikely they are carriers.

FIG. 5 is an example plot of the observed proportion of reads aligning to SMN1

$$( \frac{{D}^{′}}{r} = \hat{{π}^{′}} )$$

versus posterior likelihoods for P(π≤0.38|D′,r) under Jeffrey's prior, plotted for each subject, according to an embodiment of the invention. The posterior probability P may be understood as the probability that a point on the x-axis

$$( \frac{{D}^{′}}{r} )$$

falls to the left of the vertical dashed line at 1/3 (0.333). Subjects are represented with symbols as in FIG. 3. Subjects or patients to the left of this vertical dashed line may be considered to be carriers of SMA. The higher up on the graph these subjects fall, the higher the confidence level that they are SMA carriers.

FIG. 6 is an example plot of 95% Posterior (credible) intervals for the probability a S read is from SMN1, πᵢ, plotted for each subject i, according to an embodiment of the invention. All other subjects are represented with symbols as in FIG. 3 Subjects that did not meet the ∈ (in this case, 10%) threshold across all three loci are shown with stars. These subjects are not SMA carriers. Note the intervals for these subjects are much wider due to these subjects having low coverage. For certain subjects, reads cannot be combined across multiple positions because each position had a significantly different read ratio, usually due to low coverage. As such, the statistical calculation gains more power when the reads can be combined to obtain larger numbers. In these cases, the analysis was performed on the main loci of interest.

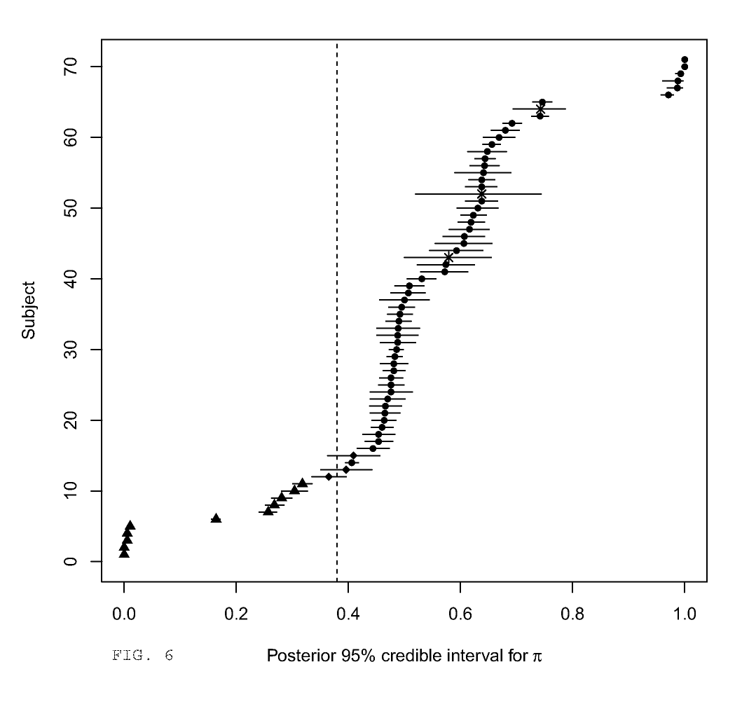

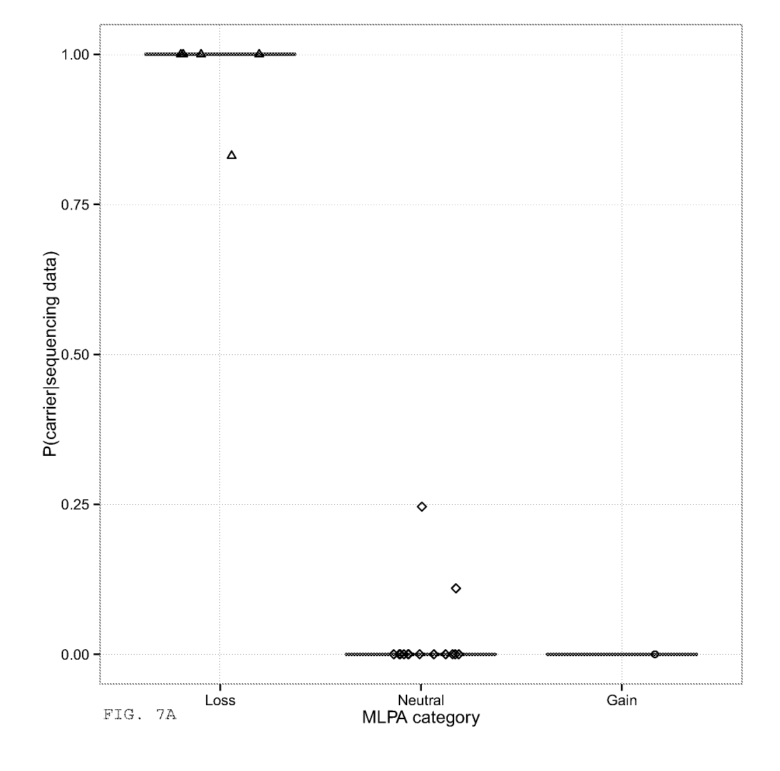

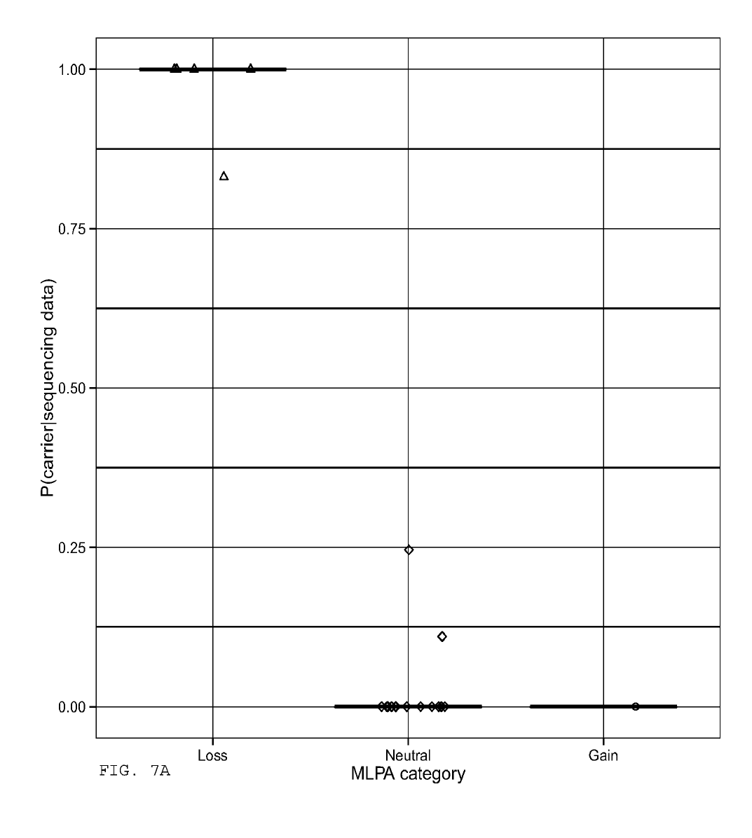

FIGS. 7A and 7B show gold standard wet lab Multiplex Ligation-dependent Probe Amplification (MLPA) SMA carrier status compared to sequencing results for 19 samples. FIG. 7A shows a Posterior probability of SMA carrier stratified by MLPA copy number characterization at SMN1 exon 7. Samples with a loss of exon 7 according to MLPA (SMA carriers) have a high probability of being a carrier according to embodiments of the invention. FIG. 7B shows a plot of MLPA ratio (SMN1 exon7 to a reference) versus the posterior probability of SMA carrier according to embodiments of the invention. Vertical lines at 0.75 and 1.25 reflect MLPA cutoffs for a loss and a gain of exon 7, respectively. Samples are represented according to their MLPA SMN1 assignments.

Returning to FIG. 2, at step 250, either once statistical models have been applied (step 235) or once the scaling factor has been applied, the processor may determine a probability of a carrier status (e.g., a carrier probability) for a given subject, as described herein.

FIG. 8A is a schematic display of a canonical genotype of SMN1 and SMN2, according to an embodiment of the invention. From an evolutionary standpoint, the human SMN1 and SMN2 genes may have been derived by duplication of a proto-SMN gene after the human-chimpanzee split. The vertical breaks represent the only functional base change that distinguishes SMN2 from SMN1 (on chromosome 5 at position 69,372,353 in the GRCh37/hg19 reference genome) which is signified on the canonical transcript position as c.840C>T. The copy number of each gene on a single chromosome is indicated in the bracket and colon formulation [SMN1:SMN2]. A canonical SMN chromosomal locus consists of one copy of each gene in the centromere-telomere order SMN2-SMN1. A canonical homozygous genotype is represented as [1:1]/[1:1].

FIG. 8B is a schematic display of a comparison of SMN1 and SMN2 sequences on either side of a gene-defining transcript position, according to an embodiment of the invention. More specifically, FIG. 8B shows a comparison of SMN1 and SMN2 sequences on either side of the gene-defining c.840C>T base difference, according to an embodiment of the invention. It is this difference which is determined by various embodiments of the invention as described herein, without requiring traditional qPCR approaches. By implementing a statistical approach as described herein, SMA carrier status can be determined from only DNA-sequencing data, and can be incorporated into cost-effective Next-Generation Sequencing (NGS) screens for the simultaneous detection of carrier status at hundreds of genes, e.g., in a large NGS carrier-testing platform.

As described above, conventional SMA screening protocol involves some form of quantitative polymerase chain reaction (qPCR) directly, or in combination with multiplex ligation-dependent probe amplification (MLPA), TaqMan, restriction fragment length polymorphism, denaturing high-performance liquid chromatography, or direct (Sanger) sequencing. qPCR primers are designed specifically to amplify segments of exon 7 containing the SMN1-defining sequence. The copy number of SMN1 is calculated by comparing its cycle threshold directly to that of a control gene(s). One of the most robust methods to detect SMA carriers presently is MLPA, a qPCR based method that utilizes fragment fluorescence intensity to determine SMN1 and SMN2 copy number. Such methods require extensive processing power and memory usage, and cannot be integrated directly into NGS screens. Embodiments of the invention therefore reduce unnecessary processing power and memory usage by enabling an SMA carrier status to be determined by using data from NGS screens, without requiring the extensive processing power and memory usage associated with present procedures for determining SMA carrier status.

It should be noted that the SMN1 and SMN2 sequences represent DNA (or portions thereof) extracted from biological samples, such as, blood, tissue, or saliva. The organism may be a living organism or a virtual organism. When screening a living organism, FIG. 8B may be an image of DNA of the living organism undergoing screening. When screening a virtual organism, FIG. 8B may be an image of DNA of one or more of two living potential parents whose DNA is combined to generate a virtual organism undergoing screening. For example, when two potential parents undergo carrier screening to predict disease or dysfunction in their potential child, the two potential parents' DNA may both be imaged, whereas when one potential parent seeks screening with a pool of donor candidates, the image of the DNA of the one potential parent may be displayed alone (without DNA images of candidate donors, e.g., for privacy issues) or together in a sequence of displays with the DNA image of each respective candidate donor. FIG. 8B may display a portion of or the entire length of a human genome, e.g., to reflect other gene-defining transcript positions.

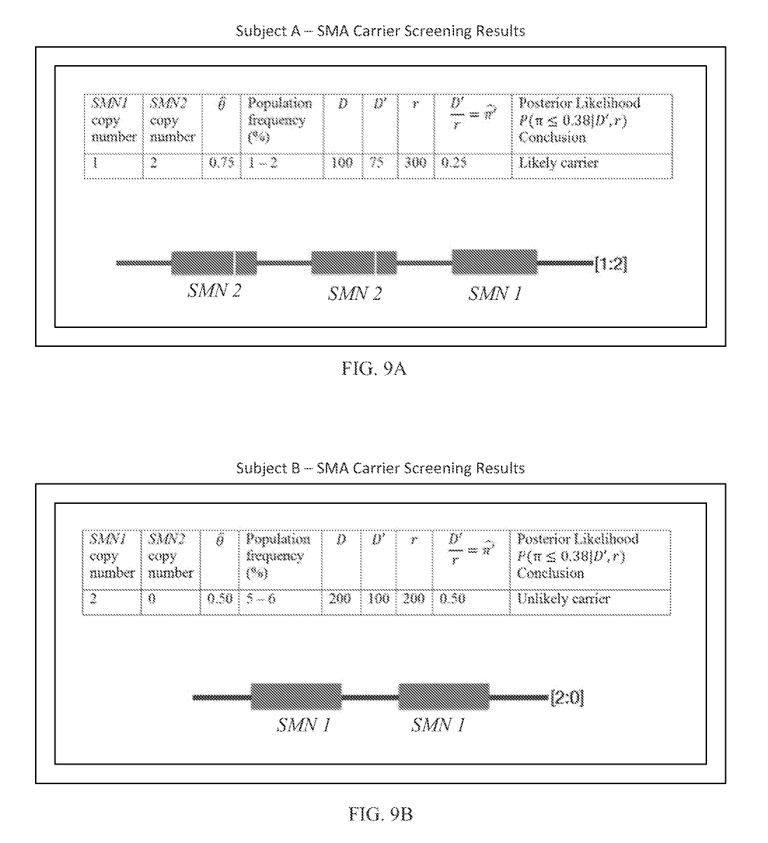

Returning to FIG. 2, at step 255, one or more results may be outputted and/or displayed on a visual display, e.g., as a physical representation of the genetic makeup of a subject tested for carrier status of SMA. In some embodiments, the display may reflect the genotype of the subject with respect to SMN1 and SMN2, similar to that of the canonical genotype of FIG. 8A (but reflecting the specific genetic makeup of the subject). For example, turning to FIG. 9A, a schematic display of results of an example SMA carrier screening for a first subject (“Subject A”) is shown along with a corresponding genotype representing the genetic makeup of the subject's SMN genes, according to an embodiment of the invention. Subject A, having a 1:2 ratio of SMN1 to SMN2, is determined to have a posterior likelihood conclusion of being a “likely carrier.” By way of another example, turning to FIG. 9B, a schematic display of results of an example SMA carrier screening for a second subject (“Subject B”) is shown along with a corresponding genotype representing the genetic makeup of the subject's SMN genes, according to an embodiment of the invention. Subject B, having a 2:0 ratio of SMN1 to SMN2, is determined to have a posterior likelihood conclusion of being an “unlikely carrier.”

In some embodiments, the display may additionally or alternatively reflect the comparison of SMN1 and SMN2 sequences on either side of the gene-defining c.840C>T base difference for the particular subject, similar to FIG. 8b. Of course, other visual representations of the results may also be provided.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method of improved genetic mutation carrier screening, performed on a computer having a processor, memory, and one or more code sets stored in the memory and executing in the processor, the method comprising:
for a plurality of genetically similar genes in a reference genome, the plurality of genetically similar genes comprising a functional gene (FG) and a non-functional gene (NFG), masking, by the processor, the NFG from the reference genome;
aligning, by the processor, a plurality of FG reads and a plurality of NFG reads of a patient's genetic sequence to the FG in the reference genome;
tallying, by the processor, at a first polymorphic locus-of-interest (LOI) on each aligned read, a respective nucleotide type, wherein FG reads comprise a different nucleotide type than NFG reads at the first polymorphic LOI; and
calculating, by the processor, based at least in part on a result of the tallying, a first gene ratio, wherein the first gene ratio indicates a first ratio of FG reads to NFG reads.

2. The method as in claim 1, further comprising:
applying, by the processor, a statistical model to the first gene ratio; and
determining, by the processor, a probability of a carrier status based at least in part on the first gene ratio.

3. The method as in claim 1, further comprising:
for at least one other polymorphic LOI on each aligned read, tallying, by the processor, a respective number of each of a plurality of nucleotide types, wherein FG reads comprise a different nucleotide type than NFG reads at the at least one other polymorphic LOI; and
calculating, by the processor, based at least in part on a result of the tallying at the at least one other polymorphic LOI, a second gene ratio, wherein the second gene ratio indicates a second ratio of FG reads to NFG reads.

4. The method as in claim 3, further comprising:
determining whether the first gene ratio and the second gene ratio are within a tolerance threshold;
applying, by the processor, a statistical model to the first gene ratio and the second gene ratio, when the first gene ratio and the second gene ratio are within a tolerance threshold; and
determining, by the processor, a probability of a carrier status given the first gene ratio and the second gene ratio.

5. The method as in claim 4, wherein the threshold tolerance is less than or equal to 10%.

6. The method as in claim 1, wherein the FG is the SMN1 gene and the NFG is the SMN2 gene.

7. The method as in claim 2, further comprising:
identifying, by the processor, one or more housekeeping genes;
calculating, by the processor, a scaling factor based on a ratio of an average number of FG reads to an average number of the one or more housekeeping genes; and
normalizing, by the processor, the determined probability of a carrier status based at least in part on the scaling factor.

8. The method as in claim 7, wherein identifying the one or more housekeeping genes further comprises:
identifying, by the processor, one or more housekeeping genes which pass a preliminary coverage filter; and
determining, by the processor, whether the one or more identified housekeeping genes at least one of:
does not exceed an average coverage variability threshold; and
does not exceed a proportion variability threshold, wherein the proportion variability threshold is applied to a proportion of an average coverage for the FG to an average coverage for a particular housekeeping gene.

9. A system for improved genetic mutation carrier screening, comprising:
a computer having:
a processor;
a memory; and
one or more code sets stored in the memory and executing in the processor, which, when executed, configure the processor to:
for a plurality of genetically similar genes in a reference genome, the plurality of genetically similar genes comprising a functional gene (FG) and a non-functional gene (NFG), mask the NFG from the reference genome;
align a plurality of FG reads and a plurality of NFG reads of a patient's genetic sequence to the FG in the reference genome;
tally at a first polymorphic locus-of-interest (LOI) on each aligned read, a respective nucleotide type, wherein FG reads comprise a different nucleotide type than NFG reads at the first polymorphic LOI; and
calculate, based at least in part on a result of the tallying, a first gene ratio, wherein the first gene ratio indicates a first ratio of FG reads to NFG reads.

10. The system as in claim 9, further configured to:
apply a statistical modeling algorithm to the first gene ratio; and
determine a probability of a carrier status based at least in part on the first gene ratio.

11. The system as in claim 9, further configured to:
for at least one other polymorphic LOI on each aligned read, tally a respective nucleotide type, wherein FG reads comprise a different nucleotide type than NFG reads at the at least one other polymorphic LOI; and
calculate, based at least in part on a result of the tallying at the at least one other polymorphic LOI, a second gene ratio, wherein the second gene ratio indicates a second ratio of FG reads to NFG reads.

12. The system as in claim 11, further configured to:
determine whether the first gene ratio and the second gene ratio are within a tolerance threshold;
apply a statistical modeling algorithm to the first gene ratio and the second gene ratio, when the first gene ratio and the second gene ratio are within a tolerance threshold; and
determine a probability of a carrier status given the first gene ratio and the second gene ratio.

13. The system as in claim 12, wherein the threshold tolerance is less than or equal to 10%.

14. The system as in claim 9, wherein the FG is the SMN1 gene and the NFG is the SMN2 gene.

15. The system as in claim 10, further configured to:
identify one or more housekeeping genes;
calculate a scaling factor based on a ratio of an average number of FG reads to an average number of the one or more housekeeping genes; and
normalize the determined probability of a carrier status based at least in part on the scaling factor.

16. The system as in claim 15, further configured to:
identify one or more housekeeping genes which pass a preliminary coverage filter; and
determine whether the one or more identified housekeeping genes at least one of:
does not exceed an average coverage variability threshold; and
does not exceed a proportion variability threshold, wherein the proportion variability threshold is applied to a proportion of an average coverage for the FG to an average coverage for a particular housekeeping gene.

17. A method of improved genetic mutation carrier screening, performed on a computer having a processor, memory, and one or more code sets stored in the memory and executing in the processor, the method comprising:
for a plurality of genetically similar genes in a reference genome, the plurality of genetically similar genes comprising a functional gene (FG) and a non-functional gene (NFG), aligning, by the processor, a plurality of FG reads and a plurality of NFG reads of a patient's genetic sequence to the FG in the reference genome;
tallying, by the processor, at a first polymorphic locus-of-interest (LOI) on each aligned read, a respective nucleotide type, wherein FG reads comprise a different nucleotide type than NFG reads at the first polymorphic LOI; and
calculating, by the processor, based at least in part on a result of the tallying, a first gene ratio, wherein the first gene ratio indicates a first ratio of FG reads to NFG reads.

18. The method as in claim 17, further comprising:
applying, by the processor, a statistical modeling algorithm to the first gene ratio; and
determining, by the processor, a probability of a carrier status based at least in part on the first gene ratio.

19. The method as in claim 17, further comprising:
for at least one other polymorphic LOI on each aligned read, tallying, by the processor, a respective nucleotide type, wherein FG reads comprise a different nucleotide type than NFG reads at the at least one other polymorphic LOI; and
calculating, by the processor, based at least in part on a result of the tallying at the at least one other polymorphic LOI, a second gene ratio, wherein the second gene ratio indicates a second ratio of FG reads to NFG reads.

20. The method as in claim 19, further comprising:
determining whether the first gene ratio and the second gene ratio are within a tolerance threshold;
applying, by the processor, a statistical modeling algorithm to the first gene ratio and the second gene ratio, when the first gene ratio and the second gene ratio are within a tolerance threshold; and
determining, by the processor, a probability of a carrier status given the first gene ratio and the second gene ratio.
